(19) United States
(12) Patent Application Publication
(10) Pub. No.: US 2008/0316176 A1
(43) Pub. Date: Dec. 25, 2008

(54) PORTABLE COMPUTER SYSTEM WITH EXTENDABLE USB-POWERED I/O DEVICE

(75) Inventors: Richard H. Deutsch, Raleigh, NC (US); Gregory R. Hintermeister, Rochester, MN (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/766,175

(22) Filed: Jun. 21, 2007

(51) Int. Cl. G06F 3/02; G06F 3/041

(52) U.S. Cl. 345/168; 345/173

(57) ABSTRACT

A laptop computer system having an extended touchpad functionality includes a base having a media bay, the base housing a microprocessor based computer system; a keyboard having a plurality of keys, the keys communicatively coupled to the microprocessor based computer system; a display screen connected to the base via first and second hinges such that the display screen is moveable between a closed position and an open position, the display screen communicatively coupled to the microprocessor based computer system to drive the display screen; and a touch-pad disposed in the media bay, the touchpad being extendable and retractable with respect to the media bay, the touch-pad configured for at least one of, (i) a drawing tablet, and (ii) configured to control the cursor movement and placement functions on the display screen. The touchpad is disposed on either a right or left opposing side of the base having the media bay and has a form factor substantially the same as a USB I/O powered device. An exemplary touchpad may further include a support member to support the touchpad in an extended position, thereby alleviating a force on an electrical connection from the touchpad to the base.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to portable computer systems, and more particularly to a portable computer system with an extendable united serial bus (USB)-powered input/output (I/O) device, such as a touchpad, for example.

2. Description of Background

A significant number of computer users prefer the mobility and convenience that portable computer systems offer. Design features try to anticipate and accommodate the needs of the mobile computer user, including providing durability during travel, reduced weight, and efficient power consumption, without compromising expected computing capabilities. As the needs of the mobile computer user continue to be met, the types of environments in which the portable computer system is used continue to grow. Thus, meeting the needs of the mobile computer user is ever-evolving due to the variety of conditions in which the portable computer systems are used.

A relatively recent trend in digital computer systems is to provide a QWERTY keyboard and a pointing device, such as a touchpad, mouse, or touchscreen. Touchpads, for example, are coordinate type pointing devices used to input coordinate type data to computer systems. The touchpad is typically a pressure-sensitive bounded plane capable of detecting localized pressure at its surface. When a user touches the surface with a finger, stylus, or the like, the touchpad reports to the attached computer system the coordinates of the location touched. In response, the computer performs the function, if any, associated with the location pressed.

It is common today for laptop computers to have a touchpad disposed below the keyboard (e.g., below the space bar key). However, many users experience lack of flexibility and comfort in using a touchpad located in such a position. There are two scenarios, for example, which is inconvenient for the user. In the first scenario, for example, the user has a deadline to submit a report in which the user needs to use the touchpad using the Internet to do heavy research online and needs to switch back to the keyboard to write the report. Switching back and forth between the keyboard and the touchpad for an extended period of time causes discomfort to the hands, and therefore the flexibility to use a mouse with a multi-touch trackpad is desired. However, there is not enough space below the keyboard to employ a multi-touch trackpad as it becomes more popular.

In the second scenario, a user is on an airplane with a laptop computer. Further, the user is a graphic designer who prefers to use a drawing tablet instead of a mouse with the laptop computer. Therefore, the user desires to connect the drawing tablet to the laptop computer. However, a food tray disposed at his seat in the airplane does not provide enough room to use both the laptop computer and the drawing tablet.

Therefore, there is still a need for a pointing device, such as a touchpad, or a drawing tablet for use with a portable laptop computer that will provide comfort and flexibility to the user.

### SUMMARY OF THE INVENTION

The shortcomings of the prior art are overcome and additional advantages are provided through the provision of a laptop computer system having an extended touchpad functionality. The system includes a base having a media bay, the base housing a microprocessor based computer system; a keyboard having a plurality of keys, the keys communicatively coupled to the microprocessor based computer system; a display screen connected to the base via first and second hinges such that the display screen is moveable between a closed position and an open position, the display screen communicatively coupled to the microprocessor based computer system to drive the display screen; and a touch-pad disposed in the media bay, the touchpad being extendable and retractable with respect to the media bay, the touch-pad configured as (i) a drawing tablet and (ii) configured to control the cursor movement and placement functions on the display screen. The touchpad is disposed on either a right or left opposing side of the base having the media bay and has a form factor substantially the same as a USB I/O powered device.

In another embodiment a method for producing a laptop computer system having extended touchpad functionality is disclosed. The method includes producing a base having a media bay, the base housing a microprocessor; embedding a keyboard having a plurality of keys in the base, the keys being communicatively coupled to the microprocessor; connecting a first display to the base via a first hinge and a second hinge, the first display being communicatively coupled to the microprocessor which drives the display; and configuring a touch-pad slidably disposed in the media bay, the touchpad being extendable and retractable with respect to the media bay. The touch-pad is configured as a drawing tablet and controls the cursor movement and placement functions on the display screen. The touchpad is slidably embedded in the base and communicatively coupled to the microprocessor via one of a universal serial bus (USB) and a wireless connection. The touchpad is disposed on either a right or left opposing side of the base having the media bay and includes a stylus detachable to the touchpad for writing on the drawing tablet. The touchpad has a form factor substantially the same as a USB I/O powered device.

In still another embodiment, a laptop computer system having an extended touchpad functionality is disclosed. The system includes a base having a media bay, the base housing a microprocessor based computer system; a keyboard having a plurality of keys, the keys communicatively coupled to the microprocessor based computer system; a display screen connected to the base via first and second hinges such that the display screen is moveable between a closed position and an open position, the display screen communicatively coupled to the microprocessor based computer system to drive the display screen; a touch-pad disposed in the media bay, the touchpad being extendable and retractable with respect to the media bay, the touch-pad including (i) a drawing tablet, (ii) a stylus detachable to the touchpad for writing on the drawing tablet and (iii) configured to control the cursor movement and placement functions on the display screen; and a support member to support the touchpad when the touchpad is in an extended position, thereby alleviating a force on an electrical connection from the touchpad to the base. The touchpad is disposed on either a right or left opposing side of the base having the media bay and the touchpad has a form factor substantially the same as a USB I/O powered device. The touchpad is communicatively coupled to the microprocessor via one of a universal serial bus (USB) and a wireless connection. The touchpad is replaceable with another USB I/O powered device.

Through the present invention, a straightforward solution allows a portable computer user to increase comfortableness and flexibility with a touchpad that is extendable from a media bat disposed on either side of the portable computer such as a laptop. These and other advantages of the aspects of the present invention will be more fully understood in conjunction with the following detailed description and accompanying drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art portable computer system.

FIG. 2 illustrates a portable computer system in accordance with the present invention.

FIG. 3 illustrates another example of a portable computer system in accordance with the present invention.

The detailed description explains the preferred embodiments of the invention, together with advantages and features, by way of example with reference to the drawings.

### DETAILED DESCRIPTION OF THE INVENTION

The present invention relates to a portable computer system with an extendable touchpad. The following description is presented to enable one of ordinary skill in the art to make and use the invention and is provided in the context of a patent application and its requirements. Although the present invention will be described in the context of an extendable touchpad of a portable computer, such as a laptop computer, various modifications to the preferred embodiment will be readily apparent to those skilled in the art and the generic principles herein may be applied to other embodiments. Thus, the present invention is not intended to be limited to the embodiments shown, but is to be accorded the widest scope consistent with the principles and features described herein.

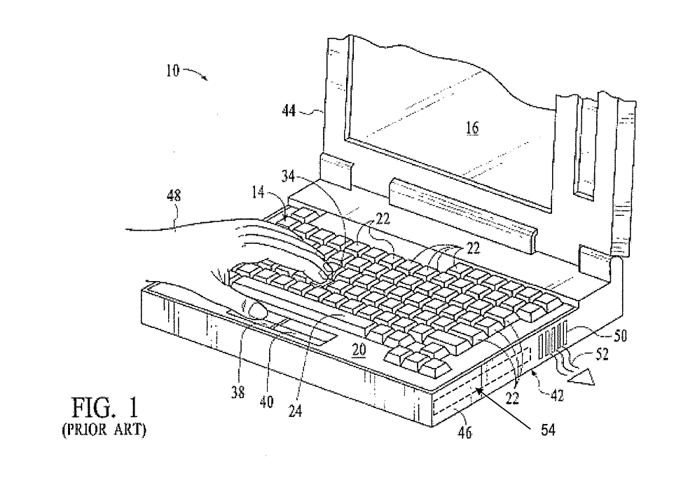

Referring to FIG. 1, a typical portable computer system 10, such as an EBM ThinkPad™, is illustrated which comprises a host processor/processing hardware (not shown) that receives manual control inputs from an attached keyboard unit 14 and displays system responses on a display screen 16 of a display device, as is commonly understood. The keyboard unit 14 includes a surrounding rectangular frame 20 that supports a plurality of manually depressible keys (as marked in part by numeral 22). The keys 22 include the normal twenty-six keys bearing the letters of the alphabet which are arranged in the conventional QWERTY layout. The keys 22 also include conventional F 1 through F 12 function keys, and other keys such as CAPS LOCK, SHIFT, TAB, BACKSPACE, ENTER and so forth, as well as a SPACE BAR key 24, CTRL key(s), ALT key(s), etc.

As is typical for ThinkPad™ systems, the keyboard unit 14 is shown having a small, substantially rigid joystick actuator 34 embedded therein, e.g., between the ‘G’, ‘H’ and ‘B’ keys. The joystick actuator 34 can be engaged by the tip of the user's index finger and lateral forces applied over a 360 degree range in the general horizontal plane of the keyboard unit 14 in order to move an active pointer across the entire display screen 16, such as to select icons, windows and other commands displayed by the GUI and to designate system tasks, change the display, and so forth. Of course, movement of the active pointer may occur via other types of selectors, for example, a touchpad that is responsive to a user's finger movement in accordance with the disclosure of the present application.

The keyboard unit 14 further includes a pair of click button assemblies 38 and 40, e.g., mounted in side-by-side relationship rearward of (or below) the space bar 24 in the wrist support of the frame 20. The click button assemblies 38 and 40 are well known to serve the same function as the click buttons on the conventional mouse widely used with personal computers.

The display screen 16 is carried on the inside of a lid 44 which is hingedly attached to the base 46 which houses the host processor/processing hardware beneath the keyboard unit 14. The lid 44 can be closed to conceal the keyboard unit 14, as is well understood in the art. As is further shown, the index finger and thumb of a user's left hand 48 are shown in engagement with the joystick actuator 34 and click button assembly 38, respectively. Of course, a user's right hand (not depicted) is also usually engaged with the keyboard 14 to select keys when typing/inputting data to the computer system 10.

Normally, portable computer systems use fans (not shown) to propel air under the keyboard unit 14 through vent openings 50 in the base 46 (shown as arrow 52) in order to dispel some of the heat generated by the host processor/processing hardware of the computer system 10. For example, it should be appreciated that the vent openings 50 depicted are illustrative and not restrictive of the number and location of vent openings on a portable computer system. Further, the location of the vent openings 50 may vary due to the presence of other device access points 54, e.g., CD/DVDs, floppy disk drives, audio output, network cards, etc., generally shown in phantom on the base 46. In accordance with the present invention, the device access point 54 may be a united serial bus (USB) powered input/output (I/O) device that fits inside a corresponding media bay such as an extendable CD/DVD drive bay, for example, or the media bay on the base 46 used for an extendable touchpad device.

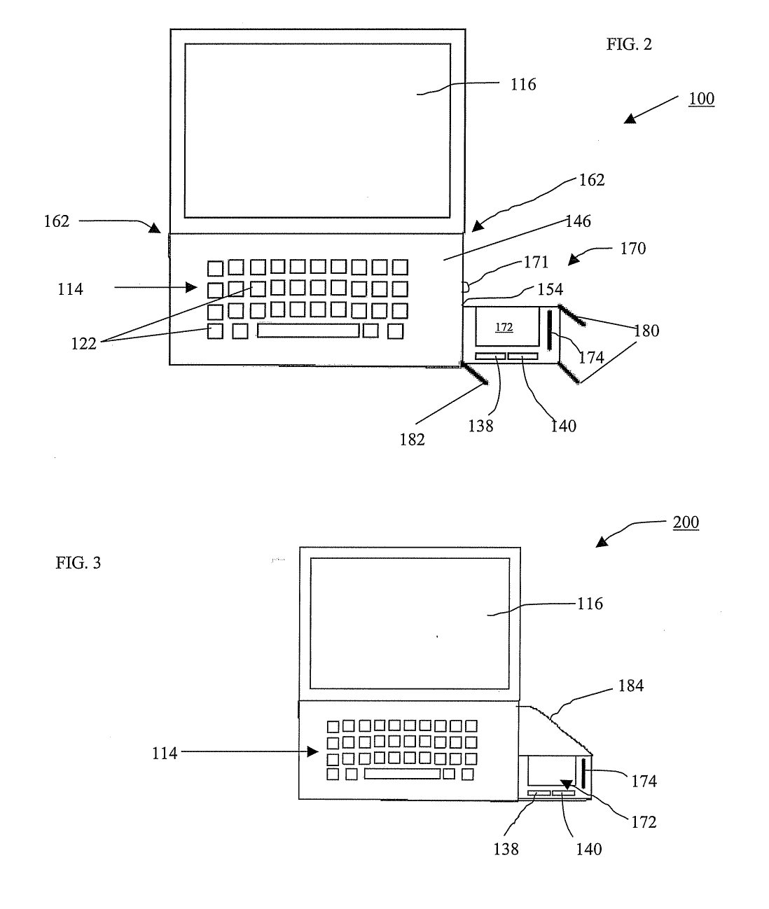

Referring now to FIG. 2, FIG. 2 illustrates a portable computer system 100 in accordance with the present invention that enhances the portable computer system 10 shown in FIG. 1 by including an extendable touchpad 160 for use with the device access point 54, such as in place or in conjunction with a DVD drive, for example, but is not limited thereto. The portable computer system 100 is a laptop computer system 100. The laptop computer system 100 includes a base 146, a keyboard unit 114, a display screen 116 and an extendable touchpad 170.

The base 146 houses a microprocessor (not shown) among other components. The microprocessor is the integrated circuit that contains the entire central processing unit of the laptop computer system 100. The microprocessor is communicatively coupled to other components housed in the base 146. Those other components include a system storage, a video controller, and a mass storage (all not shown), which are all communicatively coupled to the microprocessor via a bus (not shown) for communicating as is well known in the art.

The keyboard unit 114 is embedded in the base 146 and includes a plurality of keys 122 that are used for entering data. The keys 122, like the previous mentioned components are also communicatively coupled to the microprocessor via the bus, as is known in the pertinent art.

The display screen 116 is connected to the base 146 via first and second hinges generally shown at 162 such that the display screen 116 is moveable between a closed position where it is not viewable, and an open position where it is viewable, as shown. The display screen is communicatively coupled to the video controller (not shown), which in turn is communicatively coupled to the microprocessor. In operation, a signal is transmitted from the microprocessor by way of the bus to the video controller, which in turn drives the display screen 116.

The touchpad 170 extends from a device access point 154 and may slide out from a CD/DVD drive bay, for example, on the base 146. The extendable touchpad 170 is communicatively coupled to the microprocessor via the bus, all of which are housed in the base 146. In particular, the present disclosure provides an apparatus and method for a user to actuate a switch 171 on the base 146 or display screen 116 in order for the touchpad 170 to exit from the base 146 and from the device access point 154 (e.g., pop out from the media bay slot like a DVD drive). For example, when the user is done with the touchpad 170, the user merely activates the switch 171 (e.g., press the button again) and the touchpad 170 will slide back in to the base 146, or the user can push the touchpad 170 back into the laptop computer 100 as in a DVD drive.

The touchpad 170 includes a touchpad portion 172 being configured to control a cursor movement and placement functions on the display screen 116 and includes a pair of click button assemblies 138 and 140, e.g., mounted in side-by-side relationship and frontward of the touchpad portion 172. The click button assemblies 138 and 140 are well known to serve the same function as the click buttons on the conventional mouse widely used with personal computers.

When the touchpad portion 172 of the touchpad 170 is configured as a drawing tablet, the extendable touchpad 170 includes stylus 174 which can be detached and attached to the slide-out touchpad 170. The touchpad 170 further includes a least one support member 180 configured to absorb pressure applied to the extended touchpad 170, as opposed to the pressure being absorbed by a connection of the touchpad 170 to the base 146, thus preserving both mechanical and electrical connections thereto.

The exemplary embodiment of FIG. 2 illustrates the support member 180 as a bottom support including a plurality of support legs 182 (three shown) which extend from beneath the touchpad 170. The support legs 180 support the touchpad on a surface so that when pressure is applied to the touchpad 170, the applied pressure does not stress the interface connection between the touchpad 170 and the device access point 154. More specifically, the leg supports 180 are configured as bottom supports, or kickstands, which automatically extend (using tension rods, for example) to accommodate for touch pressure applied to the touch pad portion 172 or buttons 138, 140.

In an alternative exemplary embodiment of a laptop computer system 200 and referring to FIG. 3, the support member 180 may include one or more support wires 184 configured to be attached by the user to the laptop display screen 116 or keyboard unit 114 embedded with the base 146. The one or more support wires 184 are configured to help absorb pressure in a similar manner to the support legs 182. For example, if a user is using computer 200 on the user's lap, internal supports provided by the device access point 154 may not provide enough or suitable support, so movable support wires 184 may be added to attach to another part of the laptop computer 200 to aid in absorbing pressure put on the touchpad 170. For example, if the user is using the laptop computer 100 of FIG. 2 on the lap of the user, the leg supports 182 may not have a surface to rest on.

On the other hand, the support wire 184 can be hooked onto nearby items (e.g., laptop display screen, shirt pocket, chair, etc.) so that as pressure is applied on the extended touchpad 170, the support wire 184 absorbs the applied pressure by holding onto the touchpad via the retractable wire being fixedly clipped at an opposite end. As the retractable wire 184 is clipped to a nearby item, any extra slack can be pulled back into the touchpad 170. Then as pressure is applied, the force is on the clipped item, not the interface connection between the touchpad 170 and the device access point of the computer 200.

More specifically with reference to FIG. 3, a support wire 184 can be pulled from the touchpad 170 and hooked onto the base 146 itself. Any slack in the wires can then be taken out thus providing additional support for the extendable touchpad 170. Alternatively, the support wires may be permanently attached to the laptop housing, so that when the touchpad 170 is extended, the end of the touchpad is connected to the laptop housing via the support wires. The wire may be on a spool or rail so that when the touchpad 170 is fully extended, the support wire has proper tension to support additional pressure.

The exemplary embodiments of the present invention allow a user of a laptop to use a larger, yet integrated touchpad instead of a fixed touchpad normally located below the keyboard unit as in the prior art. It is contemplated that when a user orders a new laptop computer, the user may specify which side or which media bay of the computer the extendable touchpad is desired to be located (e.g., the user specifies if the extendable touchpad should be located on the left or right side of the laptop (e.g., the form factor may be the same as a DVD drive so that the touchpad is on one side, and the other I/O device drive is on another side).

In operation, the user merely activates the switch 171 akin to opening a DVD drive bay and the larger touchpad 170 shoots out (e.g., much like present day DVD players). Likewise, when use of the touchpad 170 is completed or it is desired to transport the laptop computer. The switch 171 is activated to return the extendable touchpad 170 to the corresponding media bay.

The above described exemplary embodiments provide a way to replace a DVD player (or other media bay item) with a USB-powered I/O device, such as a touchpad. By taking advantage of the media bay, computer makers may offer alternative I/O devices that fit inside the media bay which can be replaced as different needs arise. Exemplary embodiments of the present disclosure can also be extended to offer DVD drives that contain the touchpad on the top of the DVD device so that as the media drive is retracted into or extended from the base of the computer, the media drive is still playing through the USB connection, but the surface of the drive area contains the extendable touchpad. It also contemplated that other embodiments may include dedicated I/O devices being bluetooth® enabled to allow for wireless ability, making it possible for the touchpad to be disposed in any convenient location remote from the computer, with the empty media bay providing a docked home for the remote touchpad.

While preferred embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A laptop computer system having an extended touchpad functionality, the system comprising:
a base having a media bay, the base housing a microprocessor based computer system;
a keyboard having a plurality of keys, the keys communicatively coupled to the microprocessor based computer system;
a display screen connected to the base via first and second hinges such that the display screen is moveable between a closed position and an open position, the display screen communicatively coupled to the microprocessor based computer system to drive the display screen; and
a touch-pad disposed in the media bay, the touchpad being extendable and retractable with respect to the media bay, the touch-pad being (i) configured as a drawing tablet and (ii) configured to control the cursor movement and placement functions on the display screen,
wherein the touchpad is disposed on either a right or left opposing side of the base having the media bay and the touchpad has a form factor substantially the same as a USB I/O powered device.

2. The system of claim 1, wherein the touchpad is embedded in the base and communicatively coupled to the microprocessor via the bus.

3. The system of claim 2, wherein the touchpad is communicatively coupled to the microprocessor via one of a universal serial bus (USB) and a wireless connection.

4. The system of claim 1, wherein the touchpad is replaceable with another USB I/O powered device.

5. The system of claim 4, wherein the touchpad is mounted on a USB I/O powered device.

6. The system of claim 5, wherein the USB I/O powered device is one of a CD and a DVD drive.

7. The system of claim 1, wherein the touchpad further includes a support member to support the touchpad when the touchpad is in an extended position, thereby alleviating a force on an electrical connection from the touchpad to the base.

8. The system of claim 7, wherein the support member includes one of a bottom support and a support wire extending from the touchpad.

9. The system of claim 8, wherein the support wire is configured to clip to one of a user or the display screen.

10. The system of claim 7, wherein the bottom support includes a plurality of extension members that automatically extend to accommodate touch pressure from a user on the touchpad.

11. The system of claim 1, wherein the touchpad includes a stylus detachable to the touchpad for writing on the drawing tablet.

12. A method for producing a laptop computer system having extended touchpad functionality, the method comprising:
producing a base having a media bay, the base housing a microprocessor;
embedding a keyboard having a plurality of keys in the base, the keys being communicatively coupled to the microprocessor;
connecting a first display to the base via a first hinge and a second hinge, the first display being communicatively coupled to the microprocessor which drives the display; and
configuring a touch-pad slidably disposed in the media bay, the touchpad being extendable and retractable with respect to the media bay, the touch-pad configured as a drawing tablet and controls the cursor movement and placement functions on the display screen, the touchpad is slidably embedded in the base and communicatively coupled to the microprocessor via one of a universal serial bus (USB) and a wireless connection,
wherein the touchpad is disposed on either a right or left opposing side of the base having the media bay and includes a stylus detachable to the touchpad for writing on the drawing tablet, the touchpad having a form factor substantially the same as a USB I/O powered device.

13. The method of claim 12, further comprising replacing the touchpad with another USB I/O powered device.

14. The method of claim 13, further comprising mounting the touchpad on a USB I/O powered device.

15. The method of claim 14, wherein the USB I/O powered device is one of a CD and a DVD drive.

16. The method of claim 12, further comprising forming a support member to extend from the touchpad when the touchpad is in an extended position, thereby alleviating a force on a connection between the touchpad and the base.

17. The method of claim 15, further comprising forming the support member as one of a bottom support and a support wire extending from the touchpad.

18. A laptop computer system having an extended touchpad functionality, the system comprising:
a base having a media bay, the base housing a microprocessor based computer system;
a keyboard having a plurality of keys, the keys communicatively coupled to the microprocessor based computer system;
a display screen connected to the base via first and second hinges such that the display screen is moveable between a closed position and an open position, the display screen communicatively coupled to the microprocessor based computer system to drive the display screen;
a touch-pad disposed in the media bay, the touchpad being extendable and retractable with respect to the media bay, the touch-pad including (i) a drawing tablet, (ii) a stylus detachable to the touchpad for writing on the drawing tablet and (iii) configured to control the cursor movement and placement functions on the display screen; and
a support member to support the touchpad when the touchpad is in an extended position, thereby alleviating a force on an electrical connection from the touchpad to the base,
wherein the touchpad is disposed on either a right or left opposing side of the base having the media bay and the touchpad has a form factor substantially the same as a USB I/O powered device,
wherein the touchpad is communicatively coupled to the microprocessor via one of a universal serial bus (USB) and a wireless connection, and
wherein the touchpad is replaceable with another USB I/O powered device.
